(19) United States
(12) Patent Application Publication
(10) Pub. No.: US 2007/0117912 A1
(43) Pub. Date: May 24, 2007

(54) Polymer blend method, composition, and article

(76) Inventors: Kim G. Balfour, Delanson, NY (US); Hua Guo, Selkirk, NY (US); Mukund Parthasarathy, Delmar, NY (US)

Correspondence Address: CANTOR COLBURN, LLP, 55 GRIFFIN ROAD SOUTH, BLOOMFIELD, CT, 06002, US

(21) Appl. No.: 11/282,902

(22) Filed: Nov. 18, 2005

(51) Int. Cl. C08L 77/00

(52) U.S. Cl. 524/538

(57) ABSTRACT

A polymer blend may be prepared by melt kneading a composition that includes a poly(arylene ether), a polystyrene, and a carboxylic acid concentrate including a carboxylic acid compound and a polymer resin having a glass transition temperature or a melting temperature of about 30 to about 175° C. Using the carboxylic acid concentrate reduces the concentrations of styrene monomer and toluene in the polymer blend.

### BACKGROUND OF THE INVENTION

Thermoplastic blends of poly(arylene ether) resins and polystyrene resins are currently produced in large volumes and are highly valued for their balance of properties including stiffness, impact strength, tensile strength, dielectric properties, and heat resistance. Some properties of the blend can be superior to those of either component resin alone. See, for example, U.S. Pat. No. 3,383,435 to Cizek, which illustrates blend flexural strength, flexural modulus, compressive strength, tensile strength, impact strength, and hardness values that are superior to corresponding values for the component resins.

Many possible product applications for thermoplastic resins require that the resin be free of any objectionable odors. Considerable effort has been expended to reduce odor components associated with poly(arylene ether) resins. Poly(arylene ether) resins are typically synthesized in the presence of odoriferous organic amines, and the poly(arylene ether) resin may incorporate and later liberate such amines. Thus, one effort to reduce the odor of poly(arylene ether) resins has focused on the removal of volatile components during extrusion. For example, U.S. Pat. No. 3,633,880 to Newmark describes an extruder that includes elements to alternately compress and decompress the resin, thereby liberating volatile components, and a plurality of vacuum vents to remove the volatile components. As another example, U.S. Pat. No. 4,746,482 to Ribbing et al. describes an extrusion process whereby a polyphenylene ether resin is melt kneaded under vacuum prior to mixing with another resin.

Another source of odor in poly(arylene ether) resins is impurities in the phenol monomer, which is oxidatively polymerized to produce the poly(arylene ether). Odoriferous impurities in the 2,6-dimethylphenol monomer, such as 2,4,6-trimethylanisole, may be substantially reduced using particular distillation procedures as described in U.S. patent application Publication No. U.S. 2004-0211657 A1 to Ingelbrecht. Alternatively, the build-up of such impurities in the recycled solvent of a poly(arylene ether) process may be reduced by solvent purification methods described in U.S. Pat. No. 4,906,700 to Banevicius.

Yet another approach to reducing the odor of poly(arylene ether) resins and their blends with polystyrene has been to add materials to the extrusion process that reduce the odor of the extruded resin. For example, U.S. Pat. No. 5,017,656 to Bopp describes the addition of carboxylic acids and/or acid anhydrides during extrusion. In that reference, extruded pellets were subjectively graded for their odor, but no chemical analyses of specific odor components were reported. As another example, European Patent No. 480,244 B1 to Bopp et al. describes addition of carboxylic acids or anhydrides during extrusion, combined with “steam stripping” of the resin (i.e., addition of water to the extruder and venting of the resulting water vapor along with any other volatile components). That reference was particularly concerned with reducing the level of butanal impurity in the resin. As yet another example, U.S. Pat. No. 4,369,278 to Kasahara et al. describes extruding blends of polyphenylene ether and rubber reinforced polystyrene in an extruder with a vacuum vent, and optionally adding a pyrolysis inhibitor (e.g., a hindered phenol or a phosphite compound) and/or water to the extruder. The working examples of the Kasahara et al. patent indicate that the total content of volatiles in the resin blend may be reduced to levels as low as 2500 parts per million.

In order to serve aesthetically demanding markets such as food packaging and panels for automobile interiors, there remains a need for methods of further reducing the level of volatiles in blends of poly(arylene ether) and polystyrene resins. In particular, there is a need for methods of compounding these resins that reduce the level of styrene monomer in the resulting blend.

### BRIEF DESCRIPTION OF THE INVENTION

The above-described and other drawbacks are alleviated by a method of preparing a polymer blend, comprising: forming a polymer blend by melt kneading a composition comprising a poly(arylene ether); a polystyrene; and a carboxylic acid concentrate comprising an intimate blend comprising a carboxylic acid compound and a polymer resin having a glass transition temperature or a melting temperature of about 30 to about 175° C.

Other embodiments, including a composition prepared by the method, and an article comprising the composition, are described in detail below.

### DETAILED DESCRIPTION OF THE INVENTION

One embodiment is a method of preparing a polymer blend, comprising: forming a polymer blend by melt kneading a composition comprising a poly(arylene ether); a polystyrene; and a carboxylic acid concentrate comprising an intimate blend comprising a carboxylic acid compound and a polymer resin having a glass transition temperature or a melting temperature of about 30 to about 175° C. In the course of extensive research on reducing the concentrations of volatile impurities in poly(arylene ether)/polystyrene blends, the present inventors have determined that while many of the methods known in the art are effective for reducing the concentrations of styrene and toluene in such blends, their advantages are diminished (i.e., styrene and toluene concentrations are increased) when the blend is remelted in preparation for article formation. For example, an article molder may purchase a poly(arylene ether)/polystyrene blend having low styrene and toluene concentrations, but when the blend is remelted in preparation for injection molding, the thermal and shear stress created on remelting partially decomposes the polystyrene, thereby increasing concentrations of styrene and toluene in the injection molded article relative to the corresponding concentrations in the purchased poly(arylene ether)/polystyrene blend. By adding a relatively small amount of the carboxylic acid concentrate described herein to the purchased poly(arylene ether)/polystyrene blend, the article molder may obtain a molded article having styrene and toluene concentrations even lower than those of the purchased blend. The method is useful not only to parties who form articles comprising poly(arylene ether)/polystyrene blends, but also to parties who prepare and sell such blends.

The poly(arylene ether) used in the method may comprise repeating structural units having the formula 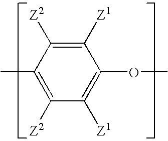
wherein for each structural unit, each Z¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each Z² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms. In one embodiment, each Z¹ is methyl and each Z² is hydrogen or methyl. In another embodiment, the poly(arylene ether) comprises 2,6-dimethyl-1,4-phenylene ether units. For example, the poly(arylene ether) may be a homopolymer of 2,6-dimethylphenol (i.e., poly(2,6-dimethyl-1,4-phenylene ether), a copolymer of 2,6-dimethylphenol and 2,3,6-trimethylphenol (i.e., poly(2,6-dimethyl-1,4-phenylene ether-co-2,3,6-trimethyl-1,4-phenylene ether), or a combination thereof.

The poly(arylene ether) may comprise molecules having aminoalkyl-containing end group(s), typically located in an ortho position to the hydroxy group. Also frequently present are tetramethyldiphenoquinone (TMDQ) end groups, typically obtained from reaction mixtures in which tetramethyldiphenoquinone by-product is present. The poly(arylene ether) may be in the form of a homopolymer; a copolymer; a graft copolymer; an ionomer; or a block copolymer; as well as combinations comprising at least one of the foregoing.

In one embodiment, the poly(arylene ether) comprises an end-capped poly(arylene ether) having the formula
Q(J-K)_{y}
wherein Q is the residuum of a monohydric, dihydric, or polyhydric phenol; y is 1 to 100, more specifically 1, 2, 3, 4, 5, or 6; J has the formula 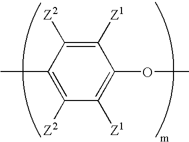
wherein each occurrence of Z¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms, and the like; each occurrence of Z² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms, and the like; m is 1 to about 200; and K is a capping group selected from 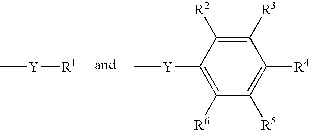
wherein R¹ is C₁-C₁₂ alkyl; R²-R⁶ are each independently selected from the group consisting of hydrogen, halogen, C₁-C₁₂ alkyl, hydroxy, carboxylic acid (—COOH), and amino; and wherein Y is a divalent group selected from 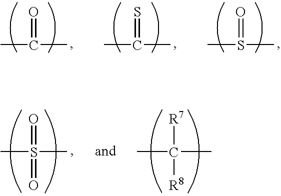
wherein R⁷ and R⁸ are each independently selected from the group consisting of hydrogen and C₁-C₁₂ alkyl.

The poly(arylene ether) may have a number average molecular weight of 3,000 to 40,000 grams per mole (g/mol) and a weight average molecular weight of 5,000 to 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) may have an initial intrinsic viscosity of 0.08 to 0.60 deciliters per gram (dl/g), as measured in chloroform at 25° C. Initial intrinsic viscosity is defined as the intrinsic viscosity of the poly(arylene ether) prior to compounding with the other components of the composition. The viscosity of the poly(arylene ether) may be up to 30% higher after compounding. A blend of poly(arylene ether) resins having different intrinsic viscosities may be used.

The polystyrene used in the method is a polymer generally comprising repeating units derived from styrene. In one embodiment, the polystyrene comprises at least 30 weight percent of repeating units derived from styrene. The styrene content of the polystyrene may be at least about 50 weight percent, at least about 60 weight percent, at least about 80 weight percent, at least about 95 weight percent, or at least about 98 weight percent. In one embodiment, the styrene content is 100 percent; i.e., the polystyrene may be a homopolystyrene. When the polystyrene comprises less than 100 weight percent of repeating units derived from styrene, it may be a random, block, or graft copolymer of styrene with at least one other copolymerizable monomer such as, for example, another alkenyl aromatic monomer (e.g., alpha-methylstyrene, para-methylstyrene, divinylbenzene), acrylonitrile, a conjugated diene (e.g., butadiene, isoprene), or maleic anhydride. For example, the polystyrene may be an acrylonitrile-butadiene-styrene copolymer having an acrylonitrile content less than about 20 weight percent. In one embodiment, a conjugated diene is used as a copolymerizable monomer to form a block copolymer. In this embodiment, the portion of the polystyrene derived from the conjugated diene may, optionally, be partially or fully hydrogenated. Also, when a conjugated diene is used as a copolymerizable monomer, the polystyrene may comprise about 30 to about 90 weight percent of repeating units derived from styrene, and about 10 to about 70 weight percent of repeating units derived from the conjugated diene. The term “block copolymer will be understood to include, for example, diblock, triblock, tetrablock, pentablock, and radial teleblock structures. The stereoregularity of the polystyrene may be atactic, syndiotactic, or isotactic. In one embodiment, the polystyrene is an amorphous polystyrene (i.e., it is not crystalline or semicrystalline). In one embodiment, the polystyrene comprises atactic homopolystyrene. In one embodiment, the polystyrene is selected from homopolystyrenes, rubber-modified polystyrenes, styrene-alpha-methylstyrene copolymers, block copolymers of styrene and a conjugated diene, hydrogenated block copolymers of styrene and a conjugated diene, and the like, and combinations thereof. A rubber-modified polystyrene is a blend and/or graft of a rubber modifier and a homopolystyrene. Preferred rubber-modified polystyrenes, also known as high-impact polystyrene or HIPS, may comprise about 88 to about 94 weight percent polystyrene and about 6 to about 12 weight percent polybutadiene, with an effective gel content of about 10% to about 35%. These rubber-modified polystyrenes are commercially available as, for example, GEH 1897 from General Electric Plastics, and EB 6755 or MA5350 from Phillips Chemical.

In one embodiment, the poly(arylene ether) and the polystyrene are provided in the form of an intimate blend that is the product of a process comprising melt kneading the poly(arylene ether) and the polystyrene. For example, a resin supplier may sell such an intimate blend to a molder, who melt-kneads it with a carboxylic acid concentrate in preparation for molding an article. In one embodiment, the poly(arylene ether) and the polystyrene are provided in the form of an intimate blend that is the product of a process comprising melt kneading the poly(arylene ether), the polystyrene, and a carboxylic acid compound such as, for example, adipic acid, glutaric acid, malonic acid, succinic acid, phthalic acid, maleic acid, citraconic acid, itaconic acid, citric acid, hydrates of the foregoing acids, anhydrides of the foregoing acids, and combinations thereof. In one embodiment, the poly(arylene ether) and the polystyrene are provided in the form of an intimate blend that is the product of a process comprising melt kneading the poly(arylene ether) and the polystyrene to form an intimate blend, and steam stripping the intimate blend. The poly(arylene ether) and the polystyrene are provided in the form of an intimate blend that is the product of a process comprising melt kneading the poly(arylene ether), the polystyrene, and a carboxylic acid compound to form an intimate blend, and steam-stripping the intimate blend.

The poly(arylene ether) and the polystyrene may be used in a weight ratio of about 10:90 to about 90:10. Within this range, the weight ratio may be at least about 20:80, or at least about 40:60. Also within this range, the weight ratio may be up to about 80:20. In calculating this weight ratio poly(arylene ether) and the polystyrene, any polystyrene incorporated via the carboxylic acid concentrate is excluded.

The method comprises melt kneading a composition comprising the poly(arylene ether), the polystyrene, and a carboxylic acid concentrate. The carboxylic acid concentrate comprises an intimate blend comprising a carboxylic acid compound and a polymer resin having a glass transition temperature or a melting temperature of about 30 to about 175° C. Apparatus suitable for preparing an intimate blend via melt kneading includes, for example, a two-roll mill, a Banbury mixer, and a single-screw or twin-screw extruder. In one embodiment, melt kneading comprises using a twin-screw extruder. The carboxylic acid compound used in the method may be a C₁-C₂₀ carboxylic acid or a C₂-C₂₀ carboxylic acid anhydride. Suitable carboxylic acids and anhydrides include monocarboxylic acids such as, for example, formic acid, acetic acid, propionic acid, butyric acid, valeric acid, caproic acid, caprylic acid, capric acid, lauric acid, myristic acid, palmitic acid, stearic acid, oleic acid, linoleic acid, linolenic acid, cyclohexanecarboxylic acid, phenylacetic acid, benzoic acid, o-toluic acid, m-toluic acid, p-toluic acid, o-chlorobenzoic acid, m-chlorobenzoic acid, p-chlorobenzoic acid, o-bromobenzoic acid, m-bromobenzoic acid, p-bromobenzoic acid, o-nitrobenzoic acid, m-nitrobenzoic acid, p-nitrobenzoic acid, salicylic acid, p-hydroxybenzoic acid, anthranilic acid, m-aminobenzoic acid, p-aminobenzoic acid, o-methoxybenzoic acid, m-methoxybenzoic acid, p-methoxybenzoic acid, methyl butyric acid, dimethylvaleric acid, phenylbutyric acid, chloromethylbutyric acid, lactic acid, dinitrobenzoic acid, methylbutanoic acid, phenylpropanoic acid, chlorophenylbutanoic acids, butenoic acids, hydrates of the foregoing acids, anhydrides of the foregoing acids, and the like, and combinations thereof. Suitable polycarboxylic acids and anhydrides further include dicarboxylic acids, tricarboxylic acids, other polycarboxylic acids, and anhydrides thereof, including, for example, malonic acid, succinic acid, glutaric acid, adipic acid, malic acid, maleic acid, fumaric acid, phthalic acid, isophthalic acid, terephthalic acid, bromoglutaric acid, dimethylglutaric acid, aconitic acid, citraconic acid, itaconic acid, citric acid, hydrates of the foregoing acids, anhydrides of the foregoing acids, and combinations thereof. In one embodiment, the carboxylic acid compound comprises citric acid.

The polymer resin used in the carboxylic acid concentrate has a glass transition temperature or a melting temperature of about 30 to about 175° C. Within this range, the glass transition temperature or the melting temperature may be at least about 50° C., or at least about 70° C., or at least about 100° C. Also within this range, the glass transition temperature or the melting temperature may be up to about 170° C., or up to about 165° C., or up to about 160° C., or up to about 155° C. Suitable polymer resins include, for example, polystyrenes, hydrocarbon waxes, hydrocarbon resins, fatty acids, polyolefins, polyesters, fluoropolymers, epoxy resins, phenolic resins, rosins and rosin derivatives, terpene resins, acrylate resins, and combinations thereof.

Suitable polystyrenes include those described above. In one embodiment, the polymer resin comprises a homopolystyrene having a weight average molecular weight of about 1,000 to about 300,000 atomic mass units. Within this range, the weight average molecular weight may be at least about 2,000 atomic mass units. Also within this range, the weight average molecular weight may be up to about 200,000 atomic mass units, or up to about 100,000 atomic mass units.

The term “hydrocarbon wax” is understood to mean a wax composed solely of carbon and of hydrogen. Suitable hydrocarbon waxes include, for example, microcrystalline waxes, polyethylene waxes, Fischer-Tropsch waxes, paraffin waxes, and combinations thereof.

Suitable hydrocarbon resins include aliphatic hydrocarbon resins, hydrogenated aliphatic hydrocarbon resins, aliphatic/aromatic hydrocarbon resins, hydrogenated aliphatic/aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and rosin esters, hydrogenated rosins and rosin esters, and mixtures of two or more thereof. As used herein, “hydrogenated”, when referring to the hydrocarbon resin, includes fully, substantially, and partially hydrogenated resins. Suitable aromatic resins include aromatic modified aliphatic resins, aromatic modified cycloaliphatic resins, and hydrogenated aromatic hydrocarbon resins having an aromatic content of about 1 to about 30%. Any of the above resins may be grafted with an unsaturated ester or anhydride using methods known in the art. Such grafting can provide enhanced properties to the resin. In one embodiment, the hydrocarbon resin in a hydrogenated aromatic hydrocarbon resin. Suitable hydrocarbon resins are commercially available and include, for example, EMPR resins, OPPERA® resins, and EMFR resins available from ExxonMobil Chemical Company; ARKON® and SUPER ESTER® rosin esters available from Arakawa Chemical Company of Japan; SYLVARES® polyterpene resins, styrenated terpene resins and terpene phenolic resins available from Arizona Chemical Company; SYLVATAC® and SYLVALITE® rosin esters available from Arizona Chemical Company; NORSOLENE® aliphatic aromatic resins available from Cray Valley; DERTOPHENE®M terpene phenolic resins and DERCOLYTE® polyterpene resins available from DRT Chemical Company; EASTOTAC® resins, PICCOTAC®resins, REGALITE® and REGALREZ® hydrogenated cycloaliphatic/aromatic resins available from Eastman Chemical Company; WINGTACK® resins available from Goodyear Chemical Company; PICCOLYTE® and PERMALYN® polyterpene resins, rosins and rosin esters available from Eastman Chemical Company; coumerone/indene resins available from Neville Chemical Company; QUINTONE® acid modified C₅ resins, C₅/C₉ resins, and acid-modified C₅/C₉ resins available from Nippon Zeon; and CLEARON® hydrogenated terpene resins available from Yasuhara.

Suitable fatty acids include, for example, oleic acid, palmitic acid, stearic acid, isostearic acid, arachidic acid, behenic acid, cerotic acid, montanic acid, and combinations thereof.

Suitable polyolefins include, for example, polyethylenes, polypropylenes, ethylene-vinyl acetate copolymers, and combinations thereof. In one embodiment, the polyolefin is a low-density polyethylene having a weight-average molecular weight of about 5,000 to about 40,000 atomic mass units. Within this range, the weight average molecular weight may be up to about 30,000 atomic mass units, or up to about 20,000 atomic mass units. In one embodiment, the polymer resin comprises a homopolystyrene having a weight average molecular weight of about 1,000 to about 300,000 atomic mass units, and a low-density polyethylene having a weight average molecular weight of about 5,000 to about 40,000 atomic mass units.

Suitable polyesters include, for example, the condensation copolymerization products of dibasic acids (including anhydrides and acid esters) and aliphatic diols. Suitable dibasic acids include, for example, terephthalic acid, isophthalic acid, phthalic acid, naphthalene dicarboxylic acid, biphenylene dicarboxylic acid, tetrahydroterephthalick acid, tetrahydroisophthalic acid, tetrahydrophthalic acid, hydronaphthalene dicarboxylic acid, cyclohexanedicarboxylic acid, cyclopentyldicarboxylic acid, cyclooctyldicarboxylic acid, glutaric acid, sebacic, adipic acid, pimelic acid, malonic acid, fumaric acid, monoesters and diesters of the foregoing, and mixtures thereof. Suitable aliphatic diols include, for example, ethylene glycol propylene glycol, butylene glycol, 1,3-propanediol, 1,3-butanediol, 1,4-butanediol, dipropylene glycol, 1,5-pentanediol, 1,6-hexanediol, diethylene glycol, 1,4-cyclohexanediol, 1,4-cyclohexanedimethanol, neopentyl glycol, 1,8-octanediol, 1,10-decanediol, 1,12-dodecanediol, diethylene glycol, triethylene glycol, tetraethylene glycol, and combinations thereof.

Suitable fluoropolymers include, for example, polytetrafluoroethylene, ethylene-tetrafluoroethylene copolymers, polyvinyidene fluoride, and combinations thereof.

Suitable epoxy resins include, for example, bisphenol A diglycidyl ether, bisphenol F diglycidyl ether, epoxy novolacs, vinyl cyclohexane dioxide, oligomers of the foregoing epoxy resins, and combinations thereof. Suitable epoxy resins are commercially available as, for example, EPON® 828, EPON® 825, D.E.R. 317, EPON® 1001F, ERL4221, and EPON® 871, all from Dow Chemical; and ARALDITE® GT7071 from Ciba Specialty Chemicals.

Suitable phenolic resins include, for example, novolac resins, resol resins, phenol-formaldehyde resins, novolacs, phenol-acetaldehyde resins, resorcinol-formaldehyde resins, phenol-furfural resins, polyvinyl phenol polymers, and combinations thereof.

Suitable rosin and rosin derivatives include, for example, tall oil rosins, gum rosins, wood rosins, hydrogenated rosins, rosin esters, and combinations thereof.

Suitable terpene resins include, for example, polymers of beta-pinene, polymers of alpha-pinene, polymers of d-limonene, terpene-phenol resins, aromatic-modified terpene resins, and combinations thereof.

Suitable acrylate resins include, for example, homopolymers and copolymers of alkyl(meth)acrylate monomers such as methyl acrylate, methyl methacrylate, ethyl acrylate, ethyl methacrylate, and the like.

The carboxylic acid concentrate may comprise about 15 to about 95 weight percent of the polymer resin and about 5 to about 85 weight percent of the carboxylic acid compound, based on the total weight of the carboxylic acid concentrate. Within the above ranges, the polymer resin amount may be at least about 50 weight percent, or at least about 60 weight percent, or at least about 70 weight percent; and the polymer resin amount may be up to about 90 weight percent, or up to about 85 weight percent. Also within the above ranges, the carboxylic acid compound amount may be at least about 10 weight percent, or at least about 15 weight percent; and the carboxylic acid compound amount may be up to about 50 weight percent, or up to about 40 weight percent, or up to about 30 weight percent. In one embodiment, the carboxylic acid concentrate comprises about 60 to about 85 weight percent of the polymer resin and about 15 to about 40 weight percent of the carboxylic acid compound.

In one embodiment, in addition to the polymer resin and the carboxylic acid compound, the carboxylic acid concentrate further comprises an additive selected from stabilizers, mold release agents, processing aids, flame retardants, drip retardants, nucleating agents, UV blockers, colorants (including dyes and pigments), particulate fillers (i.e., fillers having an aspect ratio less than about 3), reinforcing fillers, conductive fillers (e.g., single-wall and multi-wall carbon fibers), antioxidants, anti-static agents, blowing agents, and mixtures thereof. When a blowing agent is employed, it will preferably be stable to the conditions of forming the carboxylic acid concentrate and activated only during a subsequent article-forming step. Suitable blowing agents include, for example, aluminum hydroxide-based compounds; acid-carbonate based compounds such as those derived from sodium bicarbonate, hydrocerol, sodium borohydride, benzamides, hydrazodicarboxylates, dihydrooxadiazinone-based compounds, and amide derivatives of azodicarboxylic acid. Other classes of blowing agents, as well as specific blowing agents are described, for example, in Modern Plastics Encyclopedia, McGraw-Hill, Inc., Mid-October 1989 Issue, Volume 66, Number 11, pp 184-188; and U.S. Pat. No. 4,312,776 to Puri et al., U.S. Pat. No. 4,369,126 to Bathgate, U.S. Pat. No. 4,425,442 to Sato et al., U.S. Pat. No. 4,438,223 to Hunter, U.S. Pat. No. 4,444,679 to Rowland, U.S. Pat. No. 4,554,294 to Hunter et al., and U.S. Pat. No. 5,272,182 to Burnell. The carboxylic acid compound itself may serve as a blowing agent. For example, when citric acid is used as the carboxylic acid compound, it can thermally decompose to yield products including water and carbon dioxide.

The carboxylic acid concentrate may be prepared by blending the carboxylic acid compound, the polymer resin, and any optional components under conditions capable of forming an intimate blend. In one embodiment, melt blending comprises melt-kneading the carboxylic acid concentrate components at a temperature that is above the glass transition temperature or melting temperature of the polymer resin, and below the thermal decomposition temperature of the carboxylic acid compound.

The carboxylic acid concentrate may be used in an amount of about 0.5 to about 40 parts by weight per 100 parts by weight total of the poly(arylene ether) and the polystyrene. Within this range, the carboxylic acid concentrate amount may be at least about 2 parts by weight, or at least about 5 parts by weight, or at least about 8 parts by weight. Also within this range, the carboxylic acid concentrate amount may be up to about 30 parts by weight, or up to about 20 parts by weight, or up to about 10 parts by weight.

In addition to the poly(arylene ether), the polystyrene, and the carboxylic acid concentrate, the composition may, optionally, further comprise one or more additives known in the art for thermoplastic composition, including, for example, stabilizers, mold release agents, processing aids, flame retardants, drip retardants, nucleating agents, UV blockers, colorants (including dyes and pigments), particulate fillers (i.e., fillers having an aspect ratio less than about 3), reinforcing fillers, conductive fillers (e.g., single-wall and multi-wall carbon fibers), antioxidants, anti-static agents, blowing agents, and mixtures thereof.

In one embodiment, the carboxylic acid concentrate is substantially free of poly(arylene ether). In another embodiment, the carboxylic acid concentrate is substantially free of polyamide. In another embodiment, the carboxylic acid concentrate is substantially free of polyester.

In one embodiment, melt kneading the composition comprises blending with a specific energy consumption of about 0.1 to about 0.3 kilowatt-hour per kilogram of intimate blend. The term “specific energy consumption” is defined as the amount of energy required to process unit quantity of the resin through an extruder; that is, the energy consumed by the extruder per output of the extruder. Specific energy consumption may be determined by dividing the power consumed by the extruder drive motor by the total mass flow rate of the extruded product. Within the above range, the specific energy consumption may be up to about 0.2 kW-h/kg, or up to about 0.18 kW-h/kg, or up to 0.15 kW-h/kg. By using a specific energy consumption in the above range, it is possible to obtain an intimately blended resin composition yet minimize decomposition of the polystyrene and therefore minimize the concentration of styrene and other polystyrene decomposition products, including, for example, toluene, xylene, ethylbenzene, styrene dimer, and styrene trimer.

In one embodiment, melt kneading the composition occurs in an extruder, and the polystyrene has a residence time in the extruder of about 2 to about 60 seconds. Within this range, the polystyrene residence time may be up to about 30 seconds, or up to about 15 seconds, or up to about 10 seconds, or up to about 5 seconds. Polystyrene residence time may be reduced, for example, by increasing the screw rotation rate, by adding polystyrene via a downstream port, or minimizing the extruder length between polystyrene addition and the exit die. Polystyrene residence time may be determined, for example, by adding a single shot of tracer such as a pigment concentrate to the polystyrene inlet and then recording the concentration of the tracer in the extruder outlet as a function of the time after tracer addition. From this data, the mean residence time can be calculated using standard mathematical techniques.

In one embodiment, melt kneading comprises melt kneading the composition with an extruder comprising a first mixing section and a second mixing section; and melt kneading comprises adding the poly(arylene ether) to the extruder upstream of the first mixing section, and adding the polystyrene and the carboxylic acid concentrate to the extruder downstream of the first mixing section and upstream of the second mixing section.

In one embodiment, melt kneading comprises melt kneading the composition with an extruder, such that the ratio L/D is about 5 to about 45, where L is the distance between the polystyrene addition location and the blend discharge location, and D is the extruder screw diameter. Within this range, the ratio L/D may be at least about 10. Also within this range, the ratio L/D may be up to about 20. Using L/D ratios in the above range was found to be effective to allow intimate blending of the polystyrene component while minimizing the concentrations of styrene and toluene in the resin blend. The distance, L, between the polystyrene addition location and blend discharge location is measured between the centerline of the polystyrene inlet port and the end of the extruder die plate. The screw diameter is determined by the diameter of the tips of the screw element flights.

In one embodiment, the composition is melt blended with an extruder, and each extruder barrel downstream of polystyrene addition has a barrel temperature about 50 to about 120° C. above the glass transition temperature of the discharged intimate blend. Within this range, each barrel temperature may be at least about 80° C. above the glass transition temperature. Also within this range, each barrel temperature may be up to about 100° C. above the glass transition temperature. A temperature in the above range allows intimate blending yet minimizes formation of styrene and toluene. The glass transition temperature of the discharged intimate blend may be determined according to ASTM E 1640, which is a standard test method for the assignment of glass transition temperature by dynamic mechanical analysis.

There is no particular limitation on the order or mode of addition of the poly(arylene ether), the polystyrene, and the carboxylic acid concentrate to the apparatus used to form the polymer blend. When a single-screw or twin-screw extruder is used for melt kneading the composition, the components may be added in any order or in any position as long as an intimate blend is formed. In one embodiment, the poly(arylene ether) may be added upstream of the polystyrene and/or the carboxylic acid concentrate in order to minimize the thermal stress and shear stress to which the polystyrene and/or carboxylic acid concentrate are subjected to.

In one embodiment, the method further comprises shaping the polymer blend. The shaping step may include, for example, pelletization, extrusion, foam extrusion, single layer and multilayer sheet extrusion, film extrusion, profile extrusion, injection molding, blow molding, pultrusion, compression molding, thermoforming, pressure forming, hydroforming, vacuum forming, and foam molding. In one embodiment, the shaping step comprises extrusion of at least three poly(arylene ether)/polystyrene compositions to form a multilayer article comprising a foamed core layer, a first unfoamed layer disposed on one surface of the foamed core layer, and a second unfoamed layer disposed on another surface of the foamed core layer. Such multilayer articles are useful as, for example, sound absorbing panels for automobile interiors. Their fabrication is described, for example, in Japanese Patent Publication Nos. JP 2005/161789 A and JP 2005/199891 A2 to Yamaguchi et al., JP 2005/240031 to Ueno et al., and International Patent Application No. WO 2005/073299 to Uchide et al. For example, the foamed layer and unfoamed layers may be pre-formed, and each unfoamed layer may subsequently be laminated to a surface of the foamed layer by thermal fusing with a hot roller. As another example, the unfoamed layers may be pre-formed and laminated to the surface of a freshly extruded foamed layer by hot melt adhesion. As another example, the unfoamed and foamed layers may be simultaneously coextruded and laminated to each other via hot melt adhesion.

The carboxylic acid concentrate may be prepared separately from the polymer blend comprising it. Alternatively, the carboxylic acid concentrate may be prepared and in a side extruder and directly fed to the extruder used to form the polymer blend, without an intermediate step of cooling and solidifying the carboxylic acid concentrate. In one embodiment, the carboxylic acid concentrate is prepared on a side extruder as described above, and the polymer blend is fed directly to an apparatus for shaping the polymer blend. For example, the method may employ direct injection molding techniques known in the art and described, for example in International Patent Application No. WO/0243943 A1 to Adedeji et al. In one embodiment, melt kneading the poly(arylene ether), the polystyrene, and the carboxylic acid concentrate comprises melt kneading with an extruder comprising a mixing section, and wherein the poly(arylene ether), the polystyrene, and the carboxylic acid concentrate are added to the extruder upstream of the mixing section. In one embodiment, melt kneading the poly(arylene ether), the polystyrene, and the carboxylic acid concentrate comprises melt kneading with an extruder comprising a first mixing section and a second mixing section; wherein the poly(arylene ether) and the polystyrene are added to the extruder upstream of the first mixing section; and wherein the carboxylic acid concentrate is added to the extruder downstream of the first mixing section and upstream of the second mixing section.

One of the advantages of the method is that it reduces the concentrations of polystyrene decomposition products in the polymer blend. In one embodiment, the polymer blend has a toluene concentration of about 5 to about 15 parts per million by weight, based on the total weight of the polymer blend. In one embodiment, the polymer blend has a styrene concentration of about 75 to about 150 parts per million by weight, based on the total weight of the polymer blend.

One embodiment is a method of preparing a polymer blend, comprising: melt kneading a composition comprising a poly(arylene ether) comprising 2,6-dimethyl-1,4-phenylene ether units; a polystyrene selected from homopolystyrenes, rubber-modified polystyrenes, styrene-alpha-methylstyrene copolymers, block copolymers of styrene and a conjugated diene, hydrogenated block copolymers of styrene and a conjugated diene, and combinations thereof; and a carboxylic acid concentrate comprising an intimate blend comprising a polymer resin having a glass transition temperature or a melting temperature of about 30 to about 175° C.; wherein the polymer resin is selected from polystyrenes, hydrocarbon waxes, fatty acids, polyolefins, polyesters, fluoropolymers, epoxy resins, and combinations thereof; and a carboxylic acid compound selected from malonic acid, succinic acid, glutaric acid, adipic acid, malic acid, maleic acid, fumaric acid, phthalic acid, isophthalic acid, terephthalic acid, bromoglutaric acid, dimethylglutaric acid, citraconic acid, itaconic acid, citric acid, hydrates of the foregoing acids, anhydrides of the foregoing acids, and combinations thereof, to form a polymer blend.

One embodiment is a method of preparing a polymer blend, comprising: melt kneading a composition comprising about 20 to about 80 parts by weight of a poly(arylene ether) comprising 2,6-dimethyl-1,4-phenylene ether units, about 20 to about 80 parts by weight a polystyrene selected from atactic homopolystyrenes, rubber-modified polystyrenes, and combinations thereof, and about 5 to about 20 parts by weight of a carboxylic acid concentrate comprising an intimate blend comprising about 50 to about 85 weight percent of a polymer resin having a glass transition temperature or a melting temperature of about 100 to about 165° C.; wherein the polymer resin comprises a homopolystyrene having a weight average molecular weight of about 2,000 to about 300,000 atomic mass units, or a low density polyethylene having a weight average molecular weight of about 5,000 to about 40,000 atomic mass units, or a combination thereof; and about 15 to about 50 weight percent of a carboxylic acid compound comprising citric acid, to form a polymer blend. In one embodiment, the poly(arylene ether) and the polystyrene are provided in the form of an intimate blend that is the product of a process comprising melt kneading the poly(arylene ether) and the polystyrene.

One embodiment is a polymer blend prepared by any of the above described methods. The polymer blend may have a toluene concentration of about 5 to about 15 parts per million by weight and a styrene concentration of about 75 to about 150 parts per million by weight, based on the total weight of the polymer blend.

One embodiment is an article comprising a polymer blend prepared by any of the above described methods.

One embodiment is a carboxylic acid concentrate, comprising: about 15 to about 85 weight percent of a carboxylic acid compound; and about 15 to about 85 weight percent of a polymer resin having a glass transition temperature or a melting temperature of about 30 to about 175° C. In one embodiment, the carboxylic acid compound is citric acid; and the polymer resin is selected from polystyrenes, hydrocarbon waxes, fatty acids, polyolefins, polyesters, fluoropolymers, epoxy resins, phenolic resins, rosins and rosin derivatives, terpene resins, acrylate resins, and combinations thereof. In one embodiment, the carboxylic acid compound is citric acid; and the polymer resin is selected from homopolystyrenes, rubber-modified polystyrenes, styrene-butadiene block copolymers, and combinations thereof. In one embodiment, the carboxylic acid compound is citric acid; and the polymer resin comprises a homopolystyrene having a weight average molecular weight of about 2,000 to about 300,000 atomic mass units. In one embodiment, the carboxylic acid compound is citric acid; and the polymer resin comprises a low-density polyethylene having a weight average molecular weight of about 5,000 to about 40,000 atomic mass units. In one embodiment, the carboxylic acid compound is citric acid; and the polymer resin comprises an ethylene-vinyl acetate copolymer.

The invention is further illustrated by the following non-limiting examples.

### EXAMPLES 1-4, COMPARATIVE EXAMPLES 1-4

These examples illustrate the preparation of carboxylic acid concentrates and their use to reduce the concentrations of toluene and styrene when a preexisting intimate blend of poly(arylene ether) and polystyrene is reextruded.

Five citric acid concentrates were prepared using the components and amounts presented in Table 1. “Citric Acid” refers to anhydrous citric acid obtained from Cargill. “Polystyrene” refers to an atactic homopolystyrene having a number average molecular weight of about 72,000 atomic mass units and a weight average molecular weight of about 214,000 atomic mass units, obtained as NOVACOR® 2272 from Nova Chemical. “LLDPE” refers to a low density polyethylene having a density of about 0.92-0.93 gram per milliliter, a melting point of about 123° C., obtained as GI 2024A from Nova Chemical. Concentrates were compounded using a 30-millimeter diameter co-rotating, fully intermeshing, twin screw extruder. The total extruder length was 977 millimeters. Polymer resin (i.e., polystyrene, LLDPE, or both) was added in the first barrel (feed throat), and citric acid was added at barrel 6. The samples were extruded at 15.9 kilograms/hour (35 pounds/hour) at a screw speed of 300 rotations per minute (rpm). The feed components were plasticated in a mixing section located in the region between 7 and 12 screw diameters from the feed inlet. A vent was located immediately after this mixing section and operated at ambient pressure. The temperature of all barrels was set to 170° C. A vacuum vent was located 28 diameters from the feed inlet and was operated at about 15 kilopascals (kPa) absolute pressure. Concentrate samples were pelletized to form cylindrical pellets about 3 millimeters in diameter and about 3 millimeters long.

Comparative Examples 1-4 represent 70:30 weight/weight blends of poly(arylene ether) and polystyrene, compounded with and without citric acid, and with and without steam stripping. Samples were compounded using a 30-millimeter diameter co-rotating, fully intermeshing, twin-screw extruder. The total extruder length was 977 mm. The poly(arylene ether), polystyrene, and carboxylic acid (if any) were all added in the first barrel, which means the L/D for PS in the extruder, was 31. The samples were extruded at 15.9 kilograms/hour (35 pounds/hour) at a screw speed of 300 rotations per minute (rpm). The feed components were plasticated in a mixing section located in the region between 7 and 12 diameters from the feed inlet. A vent was located immediately after this mixing section and operated at ambient pressure. Water was injected for some samples at a location that was 24.5 screw diameters from the feed inlet in a region of additional mixing. A vacuum vent was located 28 diameters from the feed inlet and was operated at about 15 kilopascals (kPa) absolute pressure. The barrel temperature was set to 220, 280, 290, and 310° C. for 100, 50, 30, and 0% PS, respectively. These pelletized compositions were then remelted and reextruded (without any steam stripping or addition of citric acid) on a single-screw, one-inch screw diameter, Brabender extruder running at 120 rotations per minute and a barrel temperature of 300° C. Rather than being pelletized, samples were extruded into ribbon having rectangular cross-sectional dimensions of about 50 millimeters by about 1 millimeter. When citric acid was used, it was added at barrel 1 with the other components. When steam stripping was used, water was injected at a location that was 24.5 screw diameters from the feed inlet in a region of additional mixing.

Examples 1-4 illustrate reextrusion of comparative examples with added carboxylic acid concentrates. They are representative of samples that would be prepared by a party that purchases a pre-blended composition of poly(arylene ether) and polystyrene, then remelts it, optionally adding other components, in preparation for extruding a sheet or molding an article. Example 1 is a 90:10 blend of pre-compounded Comparative Example 4 and Concentrate A. Example 2 is a 96:4 blend of pre-compounded Comparative Example 4 and Concentrate E. Example 3 is a 90:10 blend of pre-compounded Comparative Example 2 and Concentrate A. Example 4 is a 96:4 blend of pre-compounded Comparative Example 2 and Concentrate E. Extrusion conditions for Examples 1-4 were the same as those for Comparative Examples 1-4.

Styrene and toluene levels in each sample were determined by dissolving 1.00 grams (+/−0.01 gram) of polymer blend in 25 milliliters of an internal standard solution consisting of 10 microliters of decane in 500 milliliters of chromatographic grade chloroform. This solution was then injected into a HP5989B mass spectrometer equipped with a HP5890 gas chromatograph, HP7673A auto injector, and DOS based Chemstation. The concentration of styrene and toluene was then compared against the known concentration of decane. Concentrations of styrene and toluene are expressed in units of parts per million (ppm) by weight, based on the total weight of the composition.

The results, presented in Table 1, indicate that reextrusion of poly(arylene ether)/polystyrene intimate blends with carboxylic acid concentrates reduced the concentrations of toluene and styrene, even though the total concentration of polystyrene was increased in reextrusion, and even though the polystyrene from the original intimate blend was subjected to thermal stress during reextrusion that would have been expected to increase the toluene and styrene concentrations. Comparison of Comparative Example 4 with Examples 1 and 2 shows that toluene was reduced from 16 ppm (C. Ex. 4) to 5 ppm (Ex. 1) and 5 ppm (Ex. 2), and that styrene was reduced from 163 ppm (C. Ex. 4) to 79 ppm (Ex. 1) and 78 ppm (Ex. 2). Comparison of Comparative Example 2 with Examples 3 and 4 shows that toluene was reduced from 32 ppm (C. Ex. 2) to 15 ppm (Ex. 3) and 21 ppm (Ex. 4), and styrene was reduced from 306 ppm (C. Ex. 2) to 165 ppm (Ex. 3) and 196 ppm (Ex. 4).

TABLE 1

| | Conc. A | Conc. B | Conc. C | Conc. D | Conc. E |
|---|---|---|---|---|---|
| Citric Acid (pbw) | 10 | 10 | 20 | 20 | 25 |
| Polystyrene (pbw) | 90 | 45 | 40 | 60 | 54 |
| LLDPE (pbw) | — | 45 | 40 | 20 | 19 |

TABLE 2

| | C. Ex. 1 | C. Ex. 2 | C. Ex. 3 | C. Ex. 4 |
|---|---|---|---|---|
| COMPONENT AMOUNTS | | | | |
| Poly(arylene ether) (pbw) | 70 | 70 | 70 | 70 |
| Polystyrene (pbw) | 30 | 30 | 30 | 30 |
| Citric Acid (pbw) | — | — | 1.5 | 1.5 |
| Steam stripping water (pbw) | — | 1 | — | 1 |
| Conc. A (pbw) | — | — | — | — |
| Conc. E (pbw) | — | — | — | — |
| Pre-compounded C. Ex. 2 | — | — | — | — |
| Pre-compounded C. Ex. 4 | — | — | — | — |
| COMPOSITION SUMMARY | | | | |
| Total Poly(arylene ether) (wt %) | 70 | 70 | 68.97 | 68.97 |
| Total Polystyrene (wt %) | 30 | 30 | 29.56 | 29.56 |
| Total Citric Acid (wt %) | — | — | 1.48 | 1.48 |
| Total LLPE (wt %) | — | — | — | — |
| VOLATILES IN EXTRUDED | | | | |
| RIBBON | | | | |
| Toluene (ppm) | 37 | 32 | 17 | 16 |
| Styrene (ppm) | 306 | 271 | 212 | 163 |

| | Ex. 1 | Ex. 2 | Ex. 3 | Ex. 4 |
|---|---|---|---|---|
| COMPOSITION | | | | |
| Poly(arylene ether) (pbw) | — | — | — | — |
| Polystyrene (pbw) | — | — | — | — |
| Citric Acid (pbw) | — | — | — | — |
| Steam stripping water (pbw) | — | — | — | — |
| Conc. A (pbw) | 10 | — | 10 | — |
| Conc. E (pbw) | — | 4 | — | 4 |
| Pre-compounded C. Ex. 2 | — | — | 90 | 96 |
| Pre-compounded C. Ex. 4 | 90 | 96 | — | — |
| COMPOSITION SUMMARY | | | | |
| Total Poly(arylene ether) (wt %) | 62.07 | 66.21 | 63.00 | 67.20 |
| Total Polystyrene (wt %) | 35.60 | 30.58 | 36.00 | 31.00 |
| Total Citric Acid (wt %) | 2.33 | 2.44 | 1.00 | 1.02 |
| Total LLPE (wt %) | — | 0.78 | — | 0.78 |
| VOLATILES IN EXTRUDED | | | | |
| RIBBON | | | | |
| Toluene (ppm) | 5 | 5 | 15 | 21 |
| Styrene (ppm) | 79 | 78 | 165 | 196 |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

All ranges disclosed herein are inclusive of the endpoints, and the endpoints are combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of preparing a polymer composition, comprising:
melt kneading a composition comprising
a poly(arylene ether),
a polystyrene, and
a carboxylic acid concentrate comprising an intimate blend comprising a carboxylic acid compound and a polymer resin having a glass transition temperature or a melting temperature of about 30 to about 175° C.;
to form a polymer composition.

2. The method of claim 1, wherein the poly(arylene ether) and the polystyrene are present in a weight ratio of about 10:90 to about 90:10.

3. The method of claim 1, wherein the carboxylic acid concentrate is present in an amount of about 0.5 to about 40 parts by weight per 100 parts by weight total of the poly(arylene ether) and the polystyrene.

4. The method of claim 1, wherein the poly(arylene ether) comprises repeating structural units having the formula 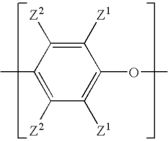
wherein for each structural unit, each Z¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; and each Z² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms.

5. The method of claim 1, wherein the poly(arylene ether) comprises 2,6-dimethyl-1,4-phenylene ether units.

6. The method of claim 1, wherein the poly(arylene ether) comprises an end-capped poly(arylene ether) having the formula
Q(J-K)_{y}
wherein Q is the residuum of a monohydric, dihydric, or polyhydric phenol; y is 1 to 100; J has the formula 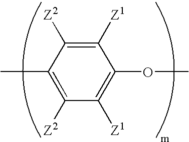
wherein each occurrence of Z¹ is independently halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; each occurrence of Z² is independently hydrogen, halogen, primary or secondary C₁-C₁₂ alkyl, C₁-C₁₂ aminoalkyl, C₁-C₁₂ hydroxyalkyl, phenyl, C₁-C₁₂ haloalkyl, C₁-C₁₂ hydrocarbyloxy, or C₁-C₁₂ halohydrocarbyloxy wherein at least two carbon atoms separate the halogen and oxygen atoms; m is 1 to about 200; and K is a capping group selected from 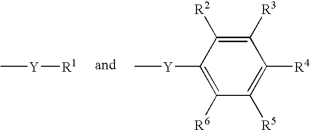
wherein R¹ is C₁-C₁₂ alkyl; R²-R⁶ are each independently selected from the group consisting of hydrogen, halogen, C₁-C₁₂ alkyl, hydroxy, carboxylic acid, and amino; and wherein Y is a divalent group selected from 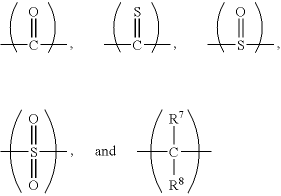
wherein R⁷ and R⁸ are each independently selected from the group consisting of hydrogen and C₁-C₁₂ alkyl.

7. The method of claim 1, wherein the polystyrene comprises at least 30 weight percent of repeating units derived from styrene.

8. The method of claim 1, wherein the polystyrene is selected from homopolystyrenes, rubber-modified polystyrenes, styrene-alpha-methylstyrene copolymers, block copolymers of styrene and a conjugated diene, hydrogenated block copolymers of styrene and a conjugated diene, and combinations thereof.

9. The method of claim 1, wherein the poly(arylene ether) and the polystyrene are provided in the form of an intimate blend that is the product of a process comprising melt kneading the poly(arylene ether) and the polystyrene.

10. The method of claim 1, wherein the poly(arylene ether) and the polystyrene are provided in the form of an intimate blend that is the product of a process comprising melt kneading the poly(arylene ether), the polystyrene, and a carboxylic acid compound selected from adipic acid, glutaric acid, malonic acid, succinic acid, phthalic acid, maleic acid, citraconic acid, itaconic acid, citric acid, hydrates of the foregoing acids, anhydrides of the foregoing acids, and combinations thereof.

11. The method of claim 1, wherein the poly(arylene ether) and the polystyrene are provided in the form of an intimate blend that is the product of a process comprising melt kneading the poly(arylene ether) and the polystyrene to form an intimate blend, and steam stripping the intimate blend.

12. The method of claim 1, wherein the carboxylic acid compound is selected from C₁-C₂₀ carboxylic acids and C₂-C₂₀ carboxylic acid anhydrides.

13. The method of claim 1, wherein the carboxylic acid compound is selected from malonic acid, succinic acid, glutaric acid, adipic acid, malic acid, maleic acid, fumaric acid, phthalic acid, isophthalic acid, terephthalic acid, bromoglutaric acid, dimethylglutaric acid, aconitic acid, citraconic acid, itaconic acid, citric acid, hydrates of the foregoing acids, anhydrides of the foregoing acids, and combinations thereof.

14. The method of claim 1, wherein the carboxylic acid compound comprises citric acid.

15. The method of claim 1, wherein the a polymer resin has a glass transition temperature or a melting temperature less than or equal to 170° C.

16. The method of claim 1, wherein the polymer resin is selected from polystyrenes, hydrocarbon waxes, hydrocarbon resins, fatty acids, polyolefins, polyesters, fluoropolymers, epoxy resins, phenolic resins, rosins and rosin derivatives, terpene resins, acrylate resins, and combinations thereof.

17. The method of claim 1, wherein the polymer resin comprises a homopolystyrene having a weight average molecular weight of about 1,000 to about 300,000 atomic mass units.

18. The method of claim 1, wherein the polymer resin comprises a low-density polyethylene having a weight average molecular weight of about 5,000 to about 40,000 atomic mass units.

19. The method of claim 1, wherein the polymer resin comprises a homopolystyrene having a weight average molecular weight of about 1,000 to about 300,000 atomic mass units, and a low-density polyethylene having a weight average molecular weight of about 5,000 to about 40,000 atomic mass units.

20. The method of claim 1, wherein the carboxylic acid concentrate comprises about 15 to about 95 weight percent of the polymer resin and about 5 to about 85 weight percent of the carboxylic acid compound.

21. The method of claim 1, wherein the carboxylic acid concentrate comprises about 60 to about 85 weight percent of the polymer resin and about 15 to about 40 weight percent of the carboxylic acid compound.

22. The method of claim 1, wherein the carboxylic acid concentrate further comprises an additive selected from stabilizers, mold release agents, processing aids, flame retardants, drip retardants, nucleating agents, UV blockers, colorants, particulate fillers, reinforcing fillers, conductive fillers, antioxidants, anti-static agents, blowing agents, and mixtures thereof.

23. The method of claim 1, wherein the composition further comprises an additive selected from stabilizers, mold release agents, processing aids, flame retardants, drip retardants, nucleating agents, UV blockers, colorants, particulate fillers, reinforcing fillers, conductive fillers, antioxidants, anti-static agents, blowing agents, and mixtures thereof.

24. The method of claim 1, wherein the carboxylic acid concentrate is substantially free of poly(arylene ether).

25. The method of claim 1, wherein said melt kneading comprises blending with a specific energy consumption of about 0.1 to about 0.3 kilowatt-hour per kilogram of intimate blend.

26. The method of claim 1, further comprising shaping the polymer composition using at least one method selected from pelletization, extrusion, foam extrusion, single layer and multilayer sheet extrusion, film extrusion, profile extrusion, injection molding, blow molding, pultrusion, compression molding, thermoforming, pressure forming, hydroforming, vacuum forming, and foam molding.

27. The method of claim 26, wherein said shaping the polymer composition comprises extruding at least three poly(arylene ether)/polystyrene compositions to form a multilayer article comprising a foamed core layer, a first unfoamed layer disposed on one surface of the foamed core layer, and a second unfoamed layer disposed on another surface of the foamed core layer.

28. The method of claim 1, wherein said melt kneading the poly(arylene ether), the polystyrene, and the carboxylic acid concentrate comprises melt kneading with an extruder comprising a mixing section, and wherein the poly(arylene ether), the polystyrene, and the carboxylic acid concentrate are added to the extruder upstream of the mixing section.

29. The method of claim 1, wherein said melt kneading the poly(arylene ether), the polystyrene, and the carboxylic acid concentrate comprises melt kneading with an extruder comprising a first mixing section and a second mixing section; wherein the poly(arylene ether) and the polystyrene are added to the extruder upstream of the first mixing section; and wherein the carboxylic acid concentrate is added to the extruder downstream of the first mixing section and upstream of the second mixing section.

30. The method of claim 1, wherein the polymer composition has a toluene concentration of about 5 to about 15 parts per million by weight, based on the total weight of the polymer composition.

31. The method of claim 1, wherein the polymer composition has a styrene concentration of about 75 to about 150 parts per million by weight, based on the total weight of the polymer composition.

32. A method of preparing a polymer composition, comprising:
melt kneading a composition comprising
a poly(arylene ether) comprising 2,6-dimethyl-1,4-phenylene ether units;
a polystyrene selected from homopolystyrenes, rubber-modified polystyrenes, styrene-alpha-methylstyrene copolymers, block copolymers of styrene and a conjugated diene, hydrogenated block copolymers of styrene and a conjugated diene, and combinations thereof, and
a carboxylic acid concentrate comprising an intimate blend comprising
a polymer resin having a glass transition temperature or a melting temperature of about 30 to about 175° C.; wherein the polymer resin is selected from polystyrenes, hydrocarbon waxes, hydrocarbon resins, fatty acids, polyolefins, polyesters, fluoropolymers, epoxy resins, phenolic resins, rosins and rosin derivatives, terpene resins, acrylate resins, and combinations thereof; and
a carboxylic acid compound selected from malonic acid, succinic acid, glutaric acid, adipic acid, malic acid, maleic acid, fumaric acid, phthalic acid, isophthalic acid, terephthalic acid, bromoglutaric acid, dimethylglutaric acid, citraconic acid, itaconic acid, citric acid, hydrates of the foregoing acids, anhydrides of the foregoing acids, and combinations thereof
to form a polymer composition.

33. A method of preparing a polymer blend, comprising:
melt kneading a composition comprising
about 20 to about 80 parts by weight of a poly(arylene ether) comprising 2,6-dimethyl-1,4-phenylene ether units,
about 20 to about 80 parts by weight a polystyrene selected from atactic homopolystyrenes, rubber-modified polystyrenes, and combinations thereof, and
about 5 to about 20 parts by weight of a carboxylic acid concentrate comprising an intimate blend comprising
about 15 to about 85 weight percent of a polymer resin having a glass transition temperature or a melting temperature of about 100 to about 160° C.; wherein the polymer resin comprises a homopolystyrene having a weight average molecular weight of about 2,000 to about 300,000 atomic mass units, or a low density polyethylene having a weight average molecular weight of about 5,000 to about 40,000 atomic mass units, or a combination thereof, and
about 15 to about 50 weight percent of a carboxylic acid compound comprising citric acid,
to form a polymer blend.

34. The method of claim 33, wherein the poly(arylene ether) and the polystyrene are provided in the form of an intimate blend that is the product of a process comprising melt kneading the poly(arylene ether) and the polystyrene.

35. A polymer blend prepared by the method of claim 1.

36. A polymer blend prepared by the method of claim 32.

37. A polymer blend prepared by the method of claim 33.

38. The polymer blend of claim 35, having a toluene concentration of about 5 to about 15 parts per million by weight and a styrene concentration of about 75 to about 150 parts per million by weight, based on the total weight of the polymer blend.

39. An article prepared by the method of claim 26.

40. An article comprising the polymer blend of claim 35.

41. An article comprising the polymer blend of claim 36.

42. An article comprising the polymer blend of claim 37.

43. A carboxylic acid concentrate, comprising:
about 15 to about 85 weight percent of a carboxylic acid compound; and
about 15 to about 85 weight percent of a polymer resin having a glass transition temperature or a melting temperature of about 50 to about 175° C.

44. The carboxylic acid concentrate of claim 43,
wherein the carboxylic acid compound is citric acid; and
wherein the polymer resin is selected from polystyrenes, hydrocarbon waxes, hydrocarbon resins, fatty acids, polyolefins, polyesters, fluoropolymers, epoxy resins, phenolic resins, rosins and rosin derivatives, terpene resins, acrylate resins, and combinations thereof.

45. The carboxylic acid concentrate of claim 43,
wherein the carboxylic acid compound is citric acid; and
wherein the polymer resin is selected from homopolystyrenes, rubber-modified polystyrenes, styrene-butadiene block copolymers, and combinations thereof.

46. The carboxylic acid concentrate of claim 43,
wherein the carboxylic acid compound is citric acid; and
wherein the polymer resin comprises a homopolystyrene having a weight average molecular weight of about 2,000 to about 300,000 atomic mass units.

47. The carboxylic acid concentrate of claim 43,
wherein the carboxylic acid compound is citric acid; and
wherein the polymer resin comprises a low-density polyethylene having a weight average molecular weight of about 5,000 to about 40,000 atomic mass units.

48. The carboxylic acid concentrate of claim 43,
wherein the carboxylic acid compound is citric acid; and
wherein the polymer resin comprises an ethylene-vinyl acetate copolymer.
